(19) United States
(12) Patent Application Publication
(10) Pub. No.: US 2012/0121844 A1
(43) Pub. Date: May 17, 2012

(54) SELF ADHESIVE ENVELOPE-LABEL (SEALED IN ROLL)

(76) Inventor: Angeliki Tzannini, Pefki (GR)

(21) Appl. No.: 13/387,220

(22) PCT Filed: Jul. 29, 2010
(86) PCT No.: PCT/GR2010/000034

§ 371 Date: Jan. 26, 2012

(30) Foreign Application Priority Data
Jul. 31, 2009 (GR) 20090100432

(51) Int. Cl. B32B 38/10; B32B 7/06

(52) U.S. Cl. 428/41.8; 156/152

(57) ABSTRACT

The product Self-adhesive Label-Envelope (sealed in a roll) (3) is a self adhesive envelope in roll (I) that includes a sticker or a simple card (2) completely enclosed, that does not have any contact with the exterior environment of the self-adhesive envelope. The production of the product The product Self-adhesive Label-Envelope (sealed in a roll) (3) is produced with a single pass on a printing machine of self adhesive labels in a roll (4) which apart from the printing stations has the possibility of opening the self-adhesive material two times—one for printing and destroying the adhesive and one for inverted (5) and internal cutting, at least two cylindrical stations of die cutting [for right and inverted cutting (5) (the station for inverted cutting should also have a rewinding unit for the waste) and a station for cold lamination with a unit for the destruction of the adhesive.

The product Self-adhesive Label-Envelope (sealed in a roll) is a self-adhesive envelope in roll comprising a sticker or a simple card completely enclosed, that does not have any contact with the exterior environment of the self-adhesive envelope.

### BRIEF DESCRIPTION OF THE DRAWINGS

FIG. 1 illustrates a front view of the present invention;

FIG. 2a shows a self-adhesive label-envelope (sealed in a roll) with internal product sticker which is constituted by cold lamination with removable adhesive;

FIG. 2b shows the Self-adhesive Label-Envelope (sealed in a roll) with internal product simple card which is constituted by cold lamination with permanent adhesive;

FIG. 3 shows the Self-adhesive Label-Envelope (sealed in a roll) placed on the product;

FIG. 4 portrays the stages of production for the Self-adhesive Label-Envelope (sealed in a roll);

FIG. 5 shows the intermediate stage of production of Self-adhesive Label-Envelope (sealed in a roll);

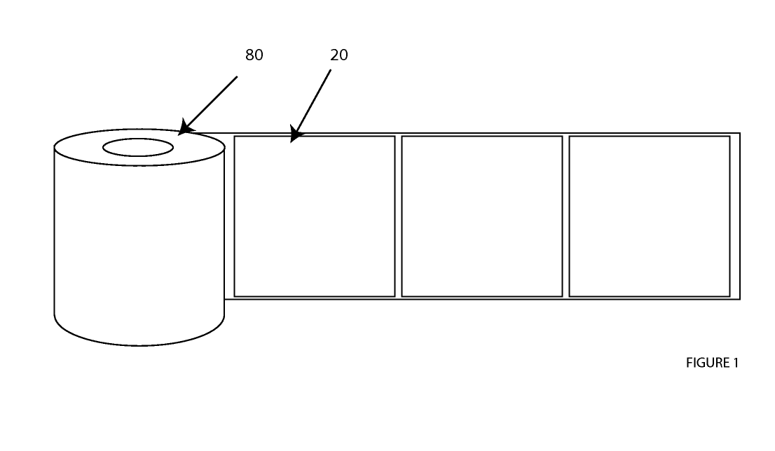

As illustrated in FIG. 1, the present invention is comprised of a self-adhesive label-envelope that is sealed in a roll 80 wherein a sticker or a simple card 20 is completely enclosed and does not have any contact with the exterior environment of the self-adhesive envelope.

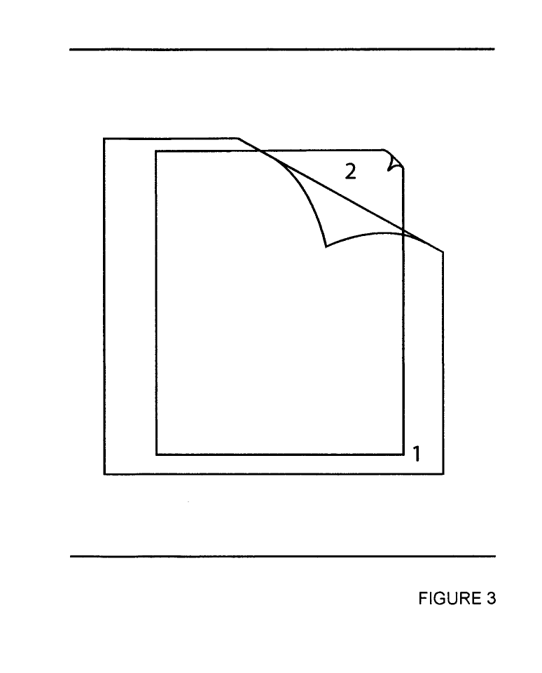

The present invention provides a self-adhesive label (envelope) that can be applied on a package with a labeling machine. The consumer, by peeling back the top layer of the lamination 19 as shown in FIG. 3 from the specific without adhesive- corner can reveal a sticker or a simple card 20 for communicational or promotional purposes etc

The raw materials that may be used for the production of the self-adhesive envelope include:

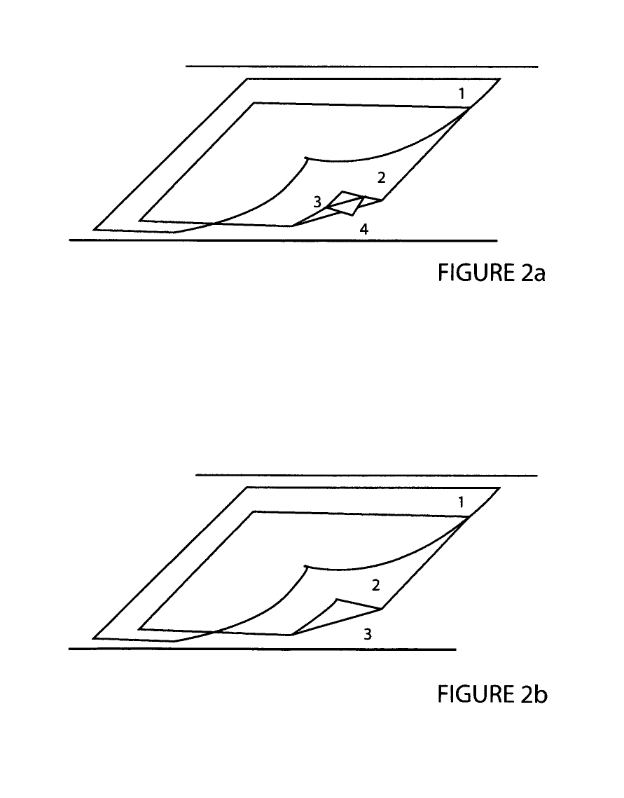

I.a. For internal product sticker: As shown in FIG. 2a, a double self-adhesive material having a liner 40, an intermediate self-adhesive 22; and a self-adhesive material 21.

I.b For internal product simple card: As shown in FIG. 2b, simple self-adhesive having a liner 40; and self-adhesive material 21.

The self-adhesive material can be any flexible material such as paper, plastic etc.

II. Cold lamination with glue (removable without release varnish or permanent with release varnish) 19 as shown in FIGS. 2a and 2b.

### DESCRIPTION OF PRODUCTION PROCESS

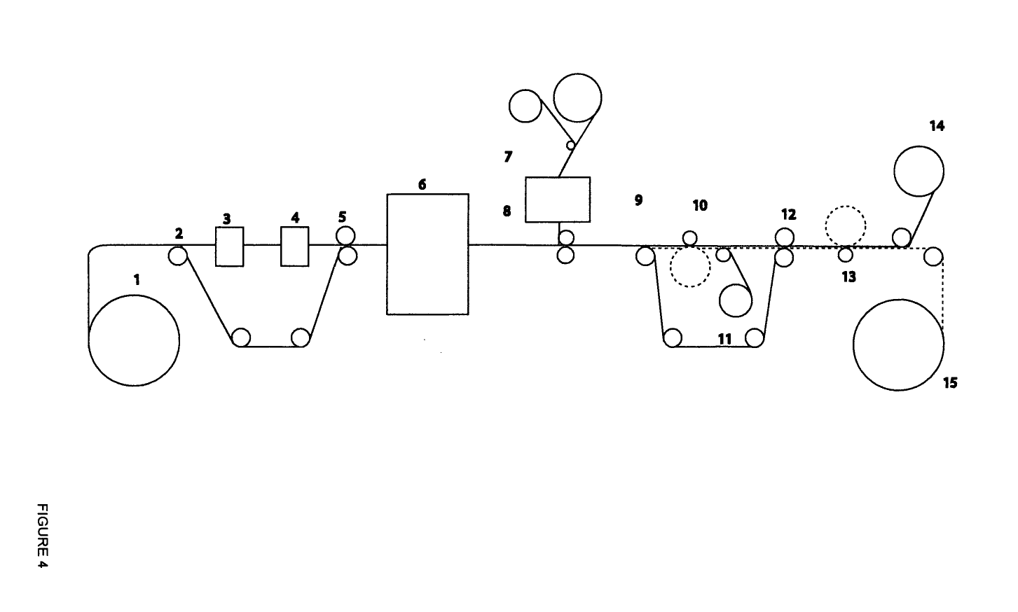

Stages of production. The stages of production are illustrated in FIG. 4. The double self- adhesive material is imported into the printing machine 1 as shown in FIG. 4. The liner is separated from the double self-adhesive material by station 2. The back side of the intermediate self-adhesive material is printed upon by station 3 of the printing machine. The glue of the intermediate self-adhesive material is destroyed, precisely behind the area that is defined from the artwork that will be printed on the front surface of the self-adhesive material by station 4. The separated materials are then recombined by station 5. Artwork may be printed on the front surface of the self-adhesive material. The printing area may be perimetrically—approximately—from half up to one centimeter smaller than the final dimension of the envelope and precisely right above the area of printing and destruction of the glue.

The double self-adhesive material is laminated via cold lamination in the lamination station 7 as shown in FIG. 4. The adhesive on the back surface of the lamination on the corner is destroyed where the lamination will be peeled of at the final product. The material that has resulted (lamination, self-adhesive material, intermediate self-adhesive material) is separated from the liner at station 9. In the first station of die cutting 10, the printing machine engraves on the reverse (back cutting) the intermediate self-adhesive material and the self-adhesive material, on the dimensions and the area where the glue is destroyed, by using the lamination as a base for the withholding of the sticker that was created internally. The waste of the engraving from the sticker or the plain card is then removed by station 11. The separated materials are then recombined in station 12. In the second die cutting station 13, the front surface is engraved in front in the final dimension. What is engraved is a sandwich of materials (lamination, self-adhesive material, intermediate self-adhesive material) using as a base the liner of the double self-adhesive material. The area of engraving will be perimetrically from half up to one centimeter bigger than the interior cut (back side cut). In the waste rewinder 14, the external part of the final cutting of the materials is collected. The final product (envelope) is collected in station 15 in roll ready form for the final slicing and quality control.

The differences of the present invention in comparison with other standard type of envelope-labels are:

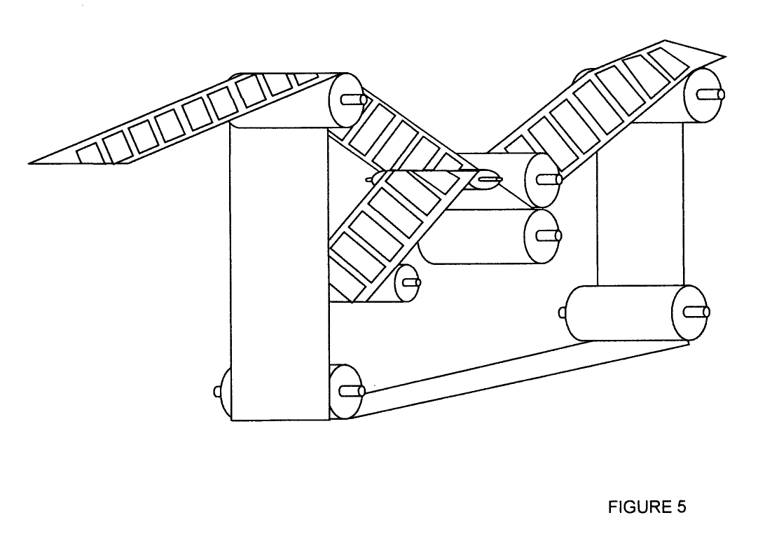

1. Referring to the production process:
g) The separation of materials for a second time before the first die cutting station as shown in FIG. 4 at stations 8, 9, and 10.
h) The destruction of adhesive at the lamination material on the specified corner as shown in FIG. 4 at station 8.
i) The reverse die cutting (back and internally) of the intermediate self-adhesive material of the double self-adhesive material, at the dimensions and the area where the glue is destroyed (for product simple card), by using the lamination material as a base for the withholding of the sticker that is created internally as shown in FIG. 5.
j) The removal of the waste from the sticker or the plain card as shown in FIG. 5 The recombination of the separated materials before the second die cutting station as shown in FIG. 4 at station 12.
k) This innovation in combination with the configuration of production as shown in FIG. 4 produces this pioneering final product.

2. Referring to the final product:

By using the above described pioneering technique, the sealed envelope that includes either a sticker or a simple card can be applied on a package with a labeling machine as shown in FIG. 1.

By using the appropriate materials, the self-adhesive envelope can be also applied internally in a food package.

FIG. 1 portrays the Self-adhesive Label-Envelope (sealed in a roll) in a roll.

FIG. 2a portrays the Self-adhesive Label-Envelope (sealed in a roll) with internal product sticker which is constituted by cold lamination with removable adhesive 19, the self-adhesive material without release varnish 21 the intermediate sticker 22 and the liner 40.

FIG. 2b portrays the Self-adhesive Label-Envelope (sealed in a roll) with internal product simple card which is constituted by cold lamination with permanent adhesive 19, the self-adhesive material with release varnish 21 and the liner 40.

FIG. 3 portrays the Self-adhesive Label-Envelope (sealed in a roll) placed on the product. By pealing of the top layer of the lamination from the specific—without adhesive—corner 19 then a sticker or a simple card is revealed 20.

FIG. 4 portrays the stages of production for the Self-adhesive Label-Envelope (sealed in a roll) in the following order: Import a roll of double self adhesive material in the printing machine 1, separation of the liner from the double self-adhesive material 2, printing on the back side of the intermediate self-adhesive material 3, printing for the destruction of the adhesive of the intermediate self-adhesive material [precisely behind the area that is defined from the artwork] 4, recombination of separated materials 5, printing artwork on the front surface of the self-adhesive material 6, cold lamination 7, destruction of adhesive on the specified corner 8, a second separation of the material that has resulted (lamination—self-adhesive material—intermediate self-adhesive material) from liner 9, reverse die cutting (back cutting of the intermediate self-adhesive material and the self-adhesive material) 9, removal of the waste 10, second recombination of the separated materials 11, die cutting in front the lamination of the self adhesive material and the intermediate self adhesive material) 12, collecting the waste of the final cutting 12 and collecting the final product 14.

FIG. 5 portrays analytically the intermediate stage of production of Self-adhesive Label-Envelope (sealed in a roll), where the printed and laminated double self-adhesive material, with the printed and destructed glue at the intermediate sticker [precisely behind the printed area of the self-adhesive material] 1 is separated from the liner 2, die cut on the back (the intermediate self-adhesive material and the self-adhesive material at the area of back printing and glue destructed) 3, the waste is removed from the sticker or the simple card 4, the product (sticker or card) is created by using as a base the lamination 5 and finally the material is recombined with the liner.

1. (canceled)

2. (canceled)

3. Method of production of a roll with a plurality of labels comprising a liner, a lamination and a plurality of labels disposed between the liner and the lamination, the method including the following steps:
providing a roll comprising a liner and a self- adhesive material,
applying a lamination on the self-adhesive material ,
separating the lamination and the self-adhesive material from the liner,
engraving the self-adhesive material, so as to produce a plurality of labels and waste material and
recombining the lamination and the self-adhesive material with the liner to form the roll with a plurality of labels.

4. Method of production of a roll with a plurality of labels comprising a liner, a lamination and a plurality of labels disposed between the liner and the lamination, the method including the following steps:
providing a roll comprising a liner and a self- adhesive material and an intermediate self-adhesive material,
applying a lamination on the self-adhesive material,
separating the lamination, the self-adhesive material and the intermediate self-adhesive material from the liner,
engraving the self-adhesive material and the intermediate self-adhesive material , so as to produce a plurality of labels and waste material and
recombining the lamination, the self-adhesive material and the intermediate self-adhesive material with the liner to form the roll with a plurality of labels.

5. Method of production of a roll with a plurality of labels according to claim 1, whereby after recombining the lamination and the self-adhesive material with the liner to form the roll with a plurality of labels, the lamination and the self-adhesive material are engraved using as a base the liner.

6. Method of production of a roll with a plurality of labels according to claim 2, whereby after recombining the lamination , the self-adhesive material and the intermediate self-adhesive material with the liner to form the roll with a plurality of labels, the lamination, the self-adhesive material and the intermediate self-adhesive material are engraved using as a base the liner.

7. Method of production of a roll with a plurality of labels according to any of claims 1 to 4, whereby removal of the waste material is effected before the recombination of the lamination and the self-adhesive material with the liner.

8. Method of production of a roll with a plurality of labels according to any of claims 1 to 5, whereby it is provided to destroy the adhesive on the back surface of the lamination at locations adjacent each label.

9. A roll with a plurality of labels including a) a liner, b) a lamination, c) a plurality of labels, whereby the lamination is in contact with the liner around the labels so that the labels are sealed between the liner and the lamination and whereby the labels have a first surface in contact with the lamination and a second surface in contact with the liner.

10. A roll with a plurality of labels according to claim 7, whereby the labels are cards.

11. A roll with a plurality of labels according to claim 7, whereby the labels are stickers and the stickers include two layers.
